(19) United States
(12) Patent Application Publication
(10) Pub. No.: US 2018/0067848 A1
(43) Pub. Date: Mar. 8, 2018

(54) MEMORY ACCESS CONTROL METHOD AND SYSTEM

(71) Applicant: Hewlett Packard Enterprise Development LP, Houston, TX (US)

(72) Inventors: Adrian John Baldwin, Bristol (GB); James Salter, Bristol (GB)

(21) Appl. No.: 15/573,662

(22) PCT Filed: Jul. 30, 2015
(86) PCT No.: PCT/EP2015/067603

§ 371 Date: Nov. 13, 2017

(51) Int. Cl. G06F 12/02; G06F 12/14; G06F 21/78; G06F 21/85

(52) U.S. Cl. CPC G06F 12/0223; G06F 12/1483; G06F 2212/1052; G06F 21/85; G06F 12/1441; G06F 21/78

(57) ABSTRACT

There is provided a memory access control method and system in which one or more memory blocks are allocated to hold data for a dataset and the one or more memory blocks are associated with metadata related to the dataset and a policy related to allowing access to the one or more memory blocks for attachment of the memory blocks to a node. Upon receiving a request from a requesting entity to access an allocated memory block for attachment of the requested memory block to a node, the policy is enforced to determine whether to allow access to the requested memory block for the attachment of the requested memory block to the node given a set of memory blocks already attached to the node.

### BACKGROUND

A computer system may have a large number of compute cores. The compute cores are connected via a memory fabric. The compute cores may wish to access memory. Memory may be non-volatile and therefore act both as storage for data and memory for the processor. Thus converging what would normally be a storage layer and a main memory layer into a single layer. There is a certain level of control over the memory (or the particular areas of memory) that each of the compute cores can access. It may be that compute cores access memory individually and/or it may be that compute cores share memory. This is also applicable in the case of a multi-tenanted computer system, where the tenants allocated to different cores of the system wish to access memory including shared memory.

### BRIEF DESCRIPTION OF DRAWINGS

For a more complete understanding, various examples will now be described below with reference to the accompanying drawings in which:

FIG. 1 is a block diagram of an example of a node according to the present disclosure;

FIG. 2 is a block diagram of an example of a network according to the present disclosure; and

FIG. 3 is an example illustration of a process which may be employed according to the present disclosure.

### DETAILED DESCRIPTION

Some examples described herein provide a node and method for controlling the way in which memory is handled and/or managed. According to the present disclosure, it is possible for an application layer to link with an identity system and a memory management system to determine whether access to a memory is allowed.

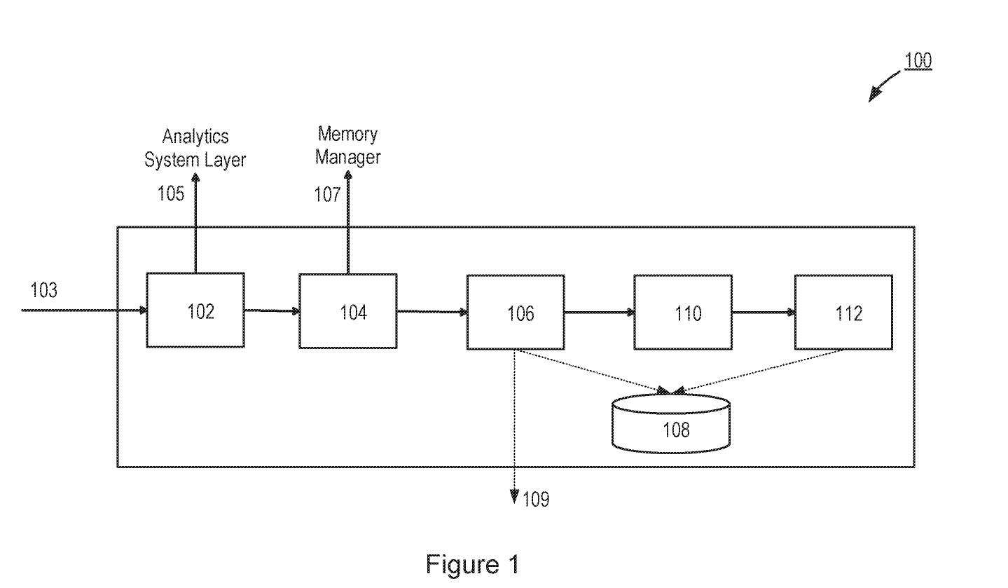

The present subject-matter is further described with reference to FIGS. 1, 2, and 3. It should be noted that the description and figures merely illustrate principles of the present subject-matter. It is thus understood that various arrangements may be devised that, although not explicitly described or shown herein, embody the principles of the present subject-matter. Moreover, all statements herein reciting principles and examples of the present-subject matter, as well as specific examples thereof, are intended to encompass equivalents thereof.

A computer system may be used to analyse or process data. Different groupings of data may be organised into datasets. An analytic process may be applied to an individual dataset or to multiple datasets. An analytic process may then create a result in an additional dataset. For example, one dataset may contain smart meter data with a second dataset containing customer information including addresses. An analytic process may, for example, generate power usage information for each region (e.g. postcode) and create a new dataset containing this information. A different analytic could generate billing information for each customer with all the records being stored in a separate dataset. Each dataset may have its own security requirements and may have different owners. The entity running the analytic process may be different from the entities owning the dataset.

At the system level, when using a converged storage and main memory layer based on non-volatile memory, each dataset may be backed by one or more memory blocks where the dataset data is stored. Where a memory block may be a set of continuous memory addresses of a given size and within a given location within a memory network. An analytic process using a dataset and running on a node needs to be able to read the memory blocks containing the data. An analytic process creating a new dataset or updating a data set needs to be able to read and write to the memory blocks containing the data of the dataset. The access to memory may be minimised to an amount sufficient to run the analytic process.

FIG. 1 illustrates a node 100 (for example, a compute node) according to the present disclosure. The node 100 comprises a receiving module 102 to receive a request 103 from a requesting entity to access datasets. For example, the request may be to run an analytic process using a number of datasets and place an output into one or more datasets (these datasets may overlap). The receiving module 102 may determine (by some method) which memory blocks are associated with the datasets by looking at metadata from an analytics system 105, 212. A memory request module 104 may obtain access information (referred to as a policy) for each memory block from a memory manager 107, 208. A policy enforcement module 106 enforces policies to determine whether to allow access to requested memory blocks (for example, by checking all policies are correct). If it is determined to allow access, the policy enforcement module 106 may request 109 that the memory network attaches the memory block to a node (for example, a compute node). The policy enforcement module 106 may also store information about attached memory in a storage 108. Analytics processes 110 can run on the node, accessing and writing data to datasets and per the request. A memory release processor 112 may remove access to memory once the analytic process has finished. The node 100 may run multiple concurrent requests 103 for memory access. The policy enforcement module 106 has a complete view on memory attached to nodes via the storage 108.

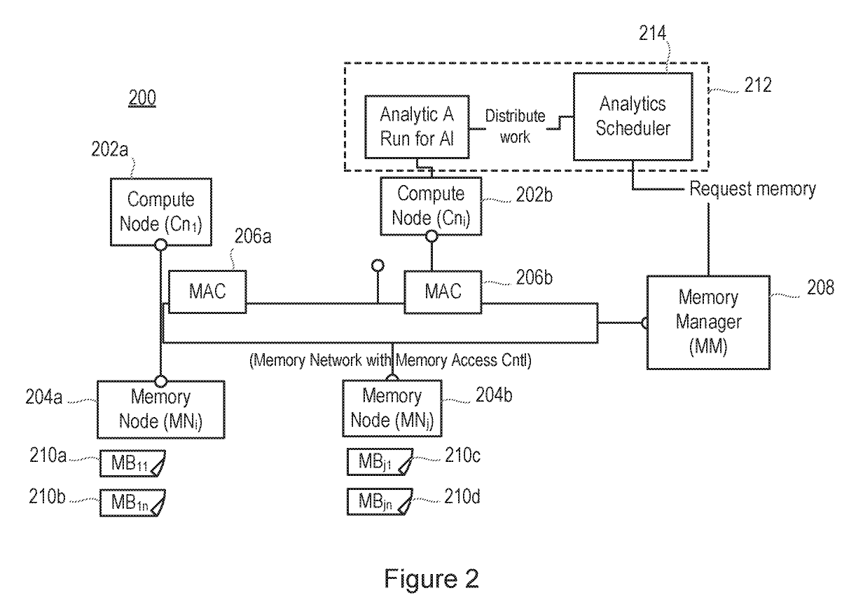

The node 100 may be one of a large number of nodes connected to a memory network. An example of such a network is shown in FIG. 2. In the example shown in FIG. 2, the node 100 may be one of a plurality of compute nodes (CNs) 202a, 202b in a memory network 200. The compute nodes 202a, 202b may be connected into the memory network 200. The memory network 200 may route memory accesses to a memory node (MN) 204a, 204b.

The node 100 may itself be defined as a plurality of cores. For example, the node 100 may be a plurality of cores within a system on a chip (SoC). In another example, the node 100 may be a single core. The node 100 may be defined as a computational unit separable over the memory network 200.

Referring to the example shown in FIG. 2, the memory network 200 may comprise one or more memory access control (MAC) functions 206a, 206b. A memory access control function 206a, 206b may be configured to control memory access such that a particular compute node has access to a set of memory addresses that the particular compute node expects to be able to access given the tasks that the compute node is performing. The memory access control function 206a, 206b may be positioned within the memory network 200 or at the edge of a compute node 202a, 202b.

The compute nodes 202a, 202b may run their own software stack, which may include an operating system (OS). The memory access control function 206a, 206b may be outside of the control of the software stack of a compute node 202a, 202b. The memory network 200 may also comprise a memory configuration point (MCP), which configures the MAC. The memory configuration point may be a remote processor, a secure process running within a secure environment (such as the policy enforcement module 106) on the compute node 100 (which may be separate from the software stack; for example, protected by TrustZone® on an ARM® processor) or may be within a memory manager (MM) 107, 208 in which case the policy enforcement module 106 acts as a proxy to the (MM) 208.

The memory network 200 may comprise the memory manager 208 to manage memory and allocate address ranges for a given purpose. The memory manager 208 may organise memory into memory blocks (MBs) 210a, 210b, 210c, 210d or it may allocate address ranges or sets of address ranges at an appropriate time. A memory block 210a, 210b, 210c, 210d may represent an address range. The memory block 210a, 210b, 210c, 210d may be of a sufficient size that the memory fabric can be configured to control access to that block. In an example, a memory block 210a, 210b, 210c, 210d may be of the order of megabytes or gigabytes.

An analytics system 105, 212 may run on nodes connected to the memory network. The analytics system 105, 212 includes management functions to allow datasets to be created, stored, extended, deleted and/or processed. As these actions are performed, there may be an allocation of memory blocks (MBs) to contain the data of the dataset. This may involve sending a request to the MM for a set of MBs to cover the predicted size of the dataset. A dataset may have an owner and a set of access control rules associated with it.

The analytics system 212 may be coded. According to the present disclosure, the analytics system 212 may comprise a scheduler 214 to attach memory blocks 210a, 210b, 210c, 210d associated with the datasets over which the analytic is running when an analytic (A) is computed on behalf of an analytic owner (AO). The scheduler 214 may allocate analytic processes or tasks to cores. In this way, the scheduler 214 has knowledge of which datasets and thus which blocks of memory are to be attached to a given node whilst the analytic is running (for example, in the receiving module 102 and the memory request module 104 in FIG. 1), The scheduler 214 may also initiate the appropriate set up such as attaching memory blocks by an appropriate route using the identity of the owner of the analytic.

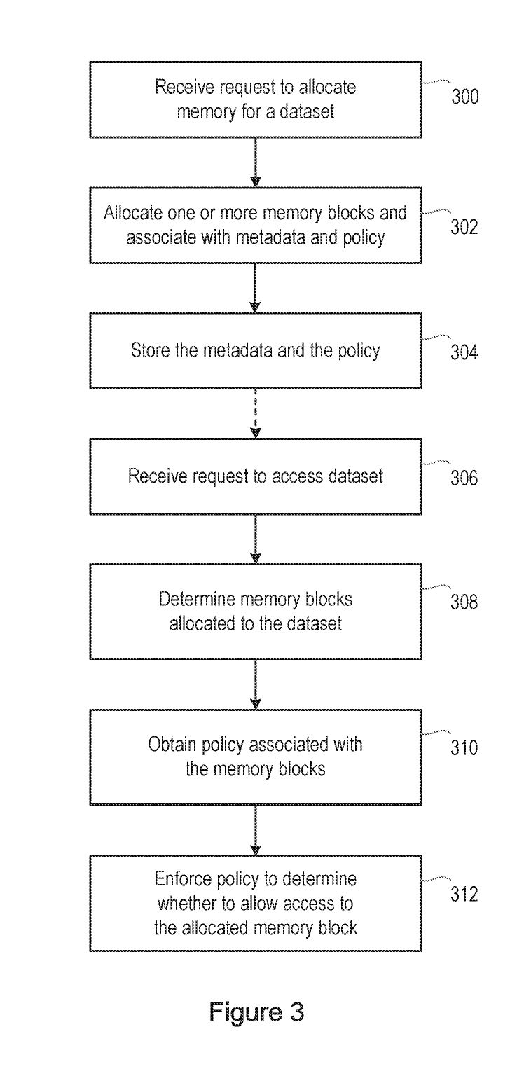

FIG. 3 is an example illustration of a process which may be employed according to the present disclosure, which will now be described (also with reference to FIG. 1 and FIG. 2). In FIG. 3, blocks 300-304 relate to a process that may be performed in the analytics system 105, 212 and blocks 306-312 relate to a process that may be performed in the node 100.

At block 300, the analytics system 105, 212 receives from an owning entity of a dataset a request to allocate memory for a dataset. For example, the analytics system 105, 212 may receive a request to create a dataset or to extend (for example, increase the size of) a dataset. The request to create a dataset may have a policy (including metadata) associated with it and may comprise an indication of a requested amount of memory. The request to extend a dataset may comprise metadata (such as a dataset name) and may provide a reference to a policy and requested additional memory. The analytics system 212 may store the association between the dataset and the memory block. At block 302, the memory manager 107, 208 allocates one or more memory blocks (for example, 210a, 210b, 210c, or 210d) to hold data for the dataset, For example, the memory manager 107, 208 may allocate one or more memory blocks to meet a requested memory size. The memory manager 107, 208 also associates the policy and metadata for the dataset with the allocated one or more memory blocks (i.e. the memory manager 107, 208 may link the policy and metadata to the allocated one or more memory blocks). In other words, as the memory block is allocated, the memory block is associated with the metadata and policy. The policy relates to allowing access to the allocated one or more memory blocks. In this way, it is possible to add control into the way in which memory is handled by creating interactions between application and memory management. For example, this may involve extending the policy information and metadata associated with each memory block to include metadata related to the dataset,

The memory manager 107, 208 may store the relationship between the memory block, metadata and policy in a secure environment.

The metadata related to the dataset may comprise information associated with the dataset, the owning entity of the dataset, the analytic requester and/or the like.

The information associated with an owning entity of the dataset may comprise an identity representation. The identity representation may comprise information uniquely identifying a data owning entity such as a unique identifier and other information associated with the owning entity. The information associated with an owning entity of the dataset may comprise information identifying the owning entity (which may be referred to as “ownersID”), an organisation (or part of an organisation) associated with the owning entity (which may be referred to as “ownersOrg”), the position of the owning entity within an organisation, the role of the owning entity within an organisation, certifications of the owning entity, and/or any other information associated with the owning entity.

The information associated with the dataset may comprise a name of the dataset, a category associated with the dataset (or any other information describing the dataset), a source of the dataset, usage properties of the dataset, a classification level for the dataset (such as secret, confidential, restricted, unclassified, unlimited, etc) and/or any other information useful for control. The usage properties of the dataset may control use of the data. For example, the usage properties may specify certain situations or applications in which the dataset may be used, export controls (such as a country of origin for the dataset and whether the dataset can be used outside that country), the purpose for which the data was collected (such as marketing, finance, etc), an entity (or part of an entity) that is allowed to access or use the data, types of process that can connect to the dataset, data lifecycle information (such as how long a connection can last/timeouts to the dataset), and/or any other usage properties.

The owning entity may be a user within the analytics system 212. The owning entity may be responsible for maintaining identity information or the identity information may come from a different source (such as an employee database).

The usage properties mentioned earlier may limit access to the datasets and hence memory blocks to a particular analytics system that manages the data. This may also restrict the analytics system to a particular software stack as defined, for example, by an attestation linked to a trusted boot process and attestation whitelist as defined by the analytics system vendor.

The metadata related to the dataset may be in the form of a set of metadata pairs such as a set of “attribute-value” pairs. In an example, the attribute may be “Company” and the value may be “Company A”, which together make up an attribute-value pair. The metadata may include a sharing alliance tag that indicates sharing is allowed with a particular entity.

The policy related to allowing access to a memory block backing a dataset (by attaching the memory block through the memory network 200 to a node) may be based on a permission level associated with the dataset. The permission level associated with the dataset may be one of “read only”, “write only” or “read/write”. In an example, the request to access a dataset may be a request to access the dataset at a certain permission level (for example, depending on whether that dataset will be updated or not). For example, the policy may include a rule mapping an identity of an entity to a permission level. In one example, the policy may include a permission level of “read only” for one entity (which indicates that this entity has permission to access the dataset but not to modify the dataset), while the policy may include a permission level of “read/write” for another entity (which indicates that this entity has permission to access the dataset and modify it). Similarly, a permission level of “write only” for an entity indicates that this entity has permission to write to the dataset but not to read the dataset.

At block 304, the analytics system 105, 212 stores the policy and metadata associated with the dataset within the memory manager 107, 208 with a link to the allocated one or more memory blocks for that dataset. Memory has then been allocated to the dataset to store data.

The dataset may then be used. The dataset may initially be used by a process that stores data into the memory (for example, an analytic or a data load process). The dataset may later be used as an input to an analytic process. However, it will be understood that other uses of the dataset are possible and in any order.

In block 306, the receiving module 102 may receive a request to access (or connect to) the dataset. The request may relate to accessing the dataset at a certain permission level, for example, in a read only mode or in a read/write mode. The request may be by an analytic owner and may relate to performing an analytic process over the dataset.

In block 308, the receiving module 102 may determine which memory blocks are allocated to (or associated with) the requested dataset. In other words, the receiving module 102 may determine which memory blocks are the requested memory blocks.

In block 310, the memory request module 104 may obtain the policy associated with the requested memory blocks from the memory manager 107, 208.

At block 312, upon receipt of the request 103 (transformed through the receiving module 102 and the memory request module 104, as discussed above) from the requesting entity to access the requested memory blocks for attachment to a node (for example, a compute node), the policy enforcing module 106 enforces the policy to determine whether to allow the requesting entity access to the allocated memory block backing the requested dataset for the attachment of the allocated memory block to the node given (i.e. depending on) the set of memory blocks already attached (or linked) to the node. For example, the policy enforcement module 106 may check that the policy is met (such as by checking that the rules or the requirements of the policy are met or maintained) and that the analytic owner is allowed access to the requested memory blocks and at which permission level. A policy may specify a metadata (or attribute value) matching process, which the policy enforcement module 106 may perform to determine whether to allow access to the requested memory blocks. More detailed examples will now be provided below.

In some examples, enforcing the policy to determine whether to allow the requesting entity access to the memory blocks backing the requested dataset for attachment to the node may involve the policy enforcing module 106 comparing metadata associated with the requested memory block to metadata associated with memory blocks currently accessible from the node. The currently accessible memory blocks and associated policies and metadata may be stored in and retrieved from the storage 108.

In one example, the policy may be written to require that the requested memory blocks are either system memory or belong to the same organisation as the memory blocks already attached to the node. In another example, the policy may be written to require that the memory blocks already attached to the node are at the same classification level or a higher classification level to the requested memory block. In another example, the policy may be written to require that the requesting entity can access the memory block for attachment to the node if the analytic process that it is running on the node is owned by an organisation operating within a certain geographical area and is not connected to other memory blocks in a read/write mode that have no geographical restriction. A policy may allow a requesting entity with a particular certification to ‘declassify’ data and move particular results to less controlled memory blocks and hence the associated dataset.

In some examples, enforcing the policy to determine whether to allow the requesting entity access to the memory block backing the requested dataset for attachment to the node may involve the policy enforcing module 106 checking attestations of the node (such as determining whether a software stack of the node is running correctly). In some examples, the policy related to allowing the requesting entity access to the requested memory block may be based on a permission level associated with the dataset (as mentioned above). In this case, enforcing the policy to determine whether to allow access to the memory block backing the requested dataset for attachment to the node may involve checking the permission level for the memory blocks already accessible on the node.

In some examples, the policy may specify the permission level required for the memory blocks already attached to the node for access to be allowed. For example, the policy may specify that where the requested memory block is a read only memory block, attachment of the requested memory block to the node will be allowed if the memory blocks already accessible on the node are read/write memory blocks.

In some examples, enforcing the policy to determine whether to allow access to the requested memory block for attachment to the node may involve comparing the metadata associated with the requested memory block to metadata associated with the memory blocks already attached to the node having the same permission level. In an example, the policy may be written to require that requested writeable memory blocks to attach have the same owner organisation as the memory blocks currently accessible from the node.

The policy may include a rule specifying when a requested memory block can be attached to the node in a read only manner given all the other attached memory blocks of the node. For example, a requested memory block may be attached to the node as readable if writable blocks attached to the node have the same usage and data type labels.

Similarly, the policy may include a rule for attaching requested memory blocks in a read/write or a write only manner. For example, there may be two datasets, one of which may comprise sensor data (such as sensor IDs, locations and data), the other of which may comprise personal data identifying the owner of the sensor. The policy may allow general use of the sensor data and may also have a rule that only allows sensor data and personal data to be attached together (for example, as identified by attributes in the metadata) where any attached writable datasets have a personal information tag in their metadata and usage restrictions matching that defined in the personal data dataset. The rule may also enforce that the readable or writable datasets have rules specifying that they can only be attached to the node when other writable datasets attached to the node also have these attributes, otherwise the attachment of the memory blocks associated with the datasets to the node will not be allowed.

In another example, if an analytic process attached to the memory blocks of the node is owned by an untrusted third party, the policy may allow access to the requested memory blocks as read-only. In another example, the policy may allow access to the requested memory blocks if all other memory blocks attached to the node are read-only.

The policy enforcing module 106 may check that writeable memory blocks attached to the node have a suitable policy to control further flow of data in order to allow attachment of requested memory blocks to the node. For example, the policy enforcing module 106 may check that each writable memory block attached to the node has a policy that restricts access to a given set of organisations or that excludes some organisations in order to allow attachment of requested memory blocks to the node. In another example, the policy enforcing module 106 may check that each writeable module has a policy that only allows memory blocks for a dataset to be attached in a read only mode or as writeable when they have restrictive policies limiting attachment of other writable memory blocks to those owned by the organisation or excluding some organisations.

Other examples of enforcing the policy to determine whether to allow access to requested memory blocks for attachment to the node may involve determining whether memory blocks currently attached to the node are compatible with the requested memory blocks, determining whether the memory blocks currently attached to the node meet a security requirement if the requested memory block were to be attached to the node, etc. The policy enforcement module 106 may ensure that all policies associated with memory blocks attached to a node are maintained, as well as those policies of the memory blocks being requested.

If it is found that access to a requested memory block for attachment to a node is not allowed (for example, if the requirements of a policy are not met or maintained by the attachment), the request to access the requested memory block for attachment to the node may be refused. If refused, the requested memory block will not be attached to the node (i.e. the requested memory block will not be added to the memory blocks attached to the node). Where a request is refused (or fails), the policy enforcement module 106 may return a signal 109 with a failure code to the requesting entity to enable the requesting entity to determine the reason for the refusal or failure.

On the other hand, if it is found that the requested memory blocks meet the requirements of a policy, the request to attach the memory blocks to the node may be allowed. If allowed, the policy enforcing module 106 may transmit a signal 109 through the memory network with an instruction to attach the requested memory block to the node (i.e. to add the requested memory block to the memory blocks attached to the node). The requested memory block will then be attached (i.e. added to the memory blocks attached to) the node. Once a request to access the memory block for attachment has been processed and allowed, the memory configuration point of the network may configure the memory access control block in the normal way.

Where the requesting entity is allowed access to a requested memory block for attachment to a node, the policy enforcement module 106 may enable the requesting entity access to the requested memory block in accordance with the policy. For example, the policy enforcement module 106 may enable the requesting entity access to the requested memory block at the appropriate permission level (as discussed above).

The policy enforcement module 106 may allow the requesting entity access to the requested memory block until a reset (such as a flag) occurs or until an attempt is made by the requesting entity to attach further memory blocks that would violate the policy of the requested memory block.

A flag may be contained in the metadata and may signal an operation that is to be performed when the policy is enforced. The flag may provide for temporal behaviour. For example, the flag may be a reset flag, which resets access to a dataset when the policy is enforced. A reset may occur where more than one entity requests memory blocks to be allocated to a given node. For example, if a first requesting entity has gained access to the memory blocks for various datasets and a second requesting entity attempts to use the same node to run their analytic process, access to those memory blocks with that flag set may be removed.

In another example, the flag may be a timer flag, which may prevent or allow access to a dataset upon expiry of a certain time period. In another example, a flag may signal to block or revoke access to memory addresses where a request to access data is received from an unknown entity or an unknown identity set (for example, an unknown system and analytic owner). The flags, or the activity associated with the flags, may be communicated to software running on the node 100 via registers or other messaging mechanisms. The flags may trigger a message. For example, the flag may be configured to return a “connect” or “do not connect” message. The message may also include error information.

The flags may be stored in the storage 108 with the policies and may be maintained in the MAC. The flags may be provided from the memory manager 107, 208 when a requesting entity requests access to a memory block for attachment to a node and the access is granted. The flags may be enforced as part of the policy enforcement. The consequences and reasons for any loss of access to memory may be flagged using memory mapped error registers from the MAC system.

There may be certain management actions that are performed according to the present disclosure. For example, policies or ownership (for example, if the owning entity leaves an organisation), associated with datasets may be updated or changed at any point and this may lead to policy and ownership changes of the memory blocks holding the data of the dataset. Additional memory blocks may be added to a dataset.

The memory manager 107, 208 and memory configuration point may be capable of retaining a record of activity, etc. There may be certain security actions that are performed. For example, messaging between the components in the memory system may be secured.

According to the present disclosure, there is provided a memory manager to allocate one or more memory blocks to hold data for a dataset and to associate the one or more memory blocks with metadata related to the dataset and a policy related to allowing access to the one or more memory blocks for adding the memory blocks to a set of memory blocks attached to a node.

According to the present disclosure, there is provided a node comprising a policy enforcing module to, upon receiving a request from a requesting entity to access an allocated memory block for adding the requested memory block to a set of memory blocks attached to a node, enforce the policy to determine whether to allow access to the requested memory block for adding the requested memory block to the node depending on the set of memory blocks already attached to the node.

According to the present disclosure, there is provided a system comprising the memory manager and the node comprising the policy enforcing module.

According to the present disclosure, there is provided a non-transitory machine-readable storage medium encoded with instructions executable by a processor. The machine-readable storage medium comprises instructions to perform at least part of the method described herein. The method may be used in conjunction with any other programs.

Examples in the present disclosure can be provided as methods, systems or machine-readable instructions, such as any combination of software, hardware, firmware or the like. Such machine-readable instructions may be included on a machine-readable storage medium (including but is not limited to disc storage, CD-ROM, optical storage, etc.) having machine-readable program code therein or thereon.

The present disclosure is described with reference to flow charts and/or block diagrams of the method, apparatus and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realised by machine-readable instructions.

The machine-readable instructions may, for example, be executed by a general purpose computer, a special purpose computer, an embedded processor or processors of other programmable data processing devices to realise the functions described in the description and figures. For example, a processing apparatus or processor may execute the machine-readable instructions. Thus, functional modules of the apparatus and devices may be implemented by a processor executing machine-readable instructions stored in a memory, or a processor operating in accordance with instructions embedded in logic circuitry. The term “processor” is to be interpreted broadly to include a processing unit, central processing unit (CPU), application-specific integrated circuit (ASIC), logic unit, programmable gate array, etc. The methods and functional modules may all be performed by a single processor or divided amongst several processors.

Such machine-readable instructions may also be stored in a machine-readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a means for realising functions specified by flow(s) in the flow charts and/or block(s) in the block diagrams.

While the method, apparatus and related aspects have been described with reference to certain examples, various modifications, changes, omissions, and substitutions can be made without departing from the spirit and scope of the present disclosure. It should be noted that the above-mentioned examples illustrate rather than limit what is described herein, and that those skilled in the art will be able to design many alternative implementations without departing from the scope of the appended claims. For example, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
allocating one or more memory blocks to hold data for a dataset and associating the one or more memory blocks with metadata related to the dataset and a policy related to allowing access to the one or more memory blocks for attachment of the memory blocks to a node;
upon receiving a request from a requesting entity to access an allocated memory block for attachment of the requested memory block to a node, enforcing the policy to determine whether to allow access to the requested memory block for the attachment of the requested memory block to the node given a set of memory blocks already attached to the node.

2. A method according to claim 1 wherein
the metadata related to the dataset comprises information associated with an owning entity of the dataset and/or information associated with the dataset.

3. A method according to claim 2 wherein
the information associated with an owning entity of the dataset comprises information identifying the owning entity and/or information identifying an organisation associated with the owning entity.

4. A method according to claim 2 wherein
the information associated with the dataset comprises a name of the dataset, a category associated with the dataset, a source of the dataset, usage properties of the dataset and/or a classification level for the dataset.

5. A method according to claim 1 wherein
enforcing the policy to determine whether to allow access to the requested memory block for attachment to the node comprises:
comparing the metadata associated with the requested memory block to metadata associated with the set of memory blocks attached to the node.

6. A method according to claim 1 wherein
the policy related to allowing access to the requested memory block for attachment to the node is based on a permission level associated with the dataset.

7. A method according to claim 6 wherein
enforcing the policy to determine whether to allow access to a requested memory block for attachment to the node comprises:
checking the permission level for the set of memory blocks attached to the node to determine whether to allow access to a requested memory block for attachment to the node,

8. A method according to claim 1 wherein
enforcing the policy to determine whether to allow access to a requested memory block for attachment to the node comprises:
determining whether the request from the requesting entity to access the requested memory block for attachment to the node is allowed.

9. A method according to claim 8 comprising:
allowing attachment of the requested memory block to the node if the request by the requesting entity is allowed.

10. A method according to claim 9 wherein
allowing attachment of the requested memory block to the node comprises:
allowing attachment of the requested memory block to the node in accordance with the policy.

11. A method according to claim 1 wherein
enforcing the policy to determine whether to allow access to a requested memory block to the node comprises:
determining whether the requested memory block is compatible with the memory block attached to the node; and/or
determining whether the requested memory block meets a security requirement if attached to the node.

12. A method according to claim 1 comprising:
storing the allocated one or more memory blocks and the associated metadata and policy in a secure environment.

13. A system comprising:
a memory manager to allocate one or more memory blocks to hold data for a dataset and to associate the one or more memory blocks with metadata related to the dataset and a policy related to allowing access to the one or more memory blocks for attachment of the one or more memory blocks to a node; and
a node comprising a policy enforcing module to, upon receiving a request from a requesting entity to access an allocated memory block for attachment of the requested memory block to a node, enforce the policy to determine whether to allow access to the requested memory block for attachment of the requested memory block to a node depending on a set of memory blocks already attached to the node.

14. A node according to claim 13 wherein the policy enforcement module is to check attestations of the node.

15. A non-transitory machine-readable storage medium encoded with instructions executable by a processor, the machine-readable storage medium comprising:
allocate one or more memory blocks to store data for a dataset and to link the one or more memory blocks with metadata related to the dataset and a policy related to allowing access to the one or more memory blocks for attachment of the one or more memory blocks to a node; and
instructions to, upon receipt of a request from a requesting entity to validate access to an allocated memory block for attachment of the requested memory block to a node, implement the policy to determine whether to validate access to the requested memory block for attachment to the node.
